(19) United States
(12) Patent Application Publication
(10) Pub. No.: US 2026/0111857 A1
(43) Pub. Date: Apr. 23, 2026

(54) LLM-BASED SCORING OF INAPPROPRIATE CONTENT

(71) Applicant: Props Media Platform, LLC, New York, NY (US)

(72) Inventors: Neil Williams, Austin, TX (US); Mohamed Abdelrehim, Portland, OR (US); Oliver Blodgett, New York, NY (US)

(21) Appl. No.: 19/365,087

(22) Filed: Oct. 21, 2025

Related U.S. Application Data
(60) Provisional application No. 63/710,391, filed on Oct. 22, 2024.

(51) Int. Cl. G06Q 50/00

(52) U.S. Cl. CPC G06Q 10/40

(57) ABSTRACT

A system ingests content items from online platforms. Each content item is associated with a content creator sponsored by an advertiser to create content items about products or services and includes one or more of free text, an image, a video, and audio. For each of the content items, the system generates a prompt for a language model. The prompt instructs the language model to generate a risk score for a respective content item and an explanation for the generated risk score. The prompt may include free text for the instructions, free text describing instructions for generating the risk score, text associated with the respective content item, and an image or video associated with the respective content item. The system generates a dashboard of rows for each content item, where each row describes a type of the content item and the risk score associated with the content item.

### CROSS REFERENCE TO RELATED APPLICATIONS

This application claims the benefit of U.S. Provisional Patent Application No. 63/710,391, filed Oct. 22, 2024, which is herein incorporated by reference in its entirety.

### BACKGROUND

Automated systems, including those that use machine learning and artificial intelligence technologies, are widely used to process large volumes of data from social media platforms. However, these systems do not inherently understand natural language because of the complexity, variability, and informality of human communication, which is difficult to model. One example of computers that need to understand natural language is in the context of social networking, which includes large amounts of unstructured natural language in the form of social media posts, comments, or other user-generated content. The unstructured natural language is highly variable and often informal, containing slang, abbreviations, emojis, misspellings, or context-dependent meanings. Because of these factors, conventional automated systems have difficulty accurately interpreting the context, sentiment, or intention behind natural language posted to social media platforms. Without being able to provide accurate interpretation of natural language, the conventional automated systems are restricted in the ability to reliably extract actionable insights from social media content. Current approaches frequently rely on superficial keyword matching or generic natural language processing algorithms that are insufficient for handling the dynamic, evolving, and often ambiguous language of social media platforms.

### SUMMARY

An online system uses generative language models to automatically evaluate social media content, particularly, content items created and posted by individuals on behalf of other users, generate a user interface that identifies potentially controversial content. The online system may continuously ingest content items from a variety of social media platforms and process each content item to determine its compliance with specific standards or guidelines, which may be provided by the advertiser associated with the respective content item. To conduct this evaluation, the online system generates prompts for each content item and transmits the prompts to a large language model (LLM). Each prompt may include any data associated with the content item, such as raw text, images, or videos, and instructs the LLM to assess the likelihood that the respective content item violates content standards. The prompt may include guidelines describing the content standard, which may be industry-standard guidelines such as the Global Alliance for Responsible Media (GARM) “Brand Safety Floor+Suitability Framework,” or custom criteria defined by the advertiser. The prompt may further include instructions for the LLM to summarize the content item or generate explanations that identify a topic of the content item, assign tags to the content item, or provide a rationale for the assigned risk score. The online system may present the output of the LLM in a graphical user interface for the advertiser to review and understand potential risks associated with content created on their behalf.

Use of such an online system provides technical benefits over conventional systems. By prompting LLMs based on guidelines for evaluating risk, the online system may more accurately interpret the natural language within content items compared to conventional systems. By constructing these prompts, the online system enables the LLM to consider the informal language, slang, abbreviations, emojis, and even context-dependent meanings frequently found in content items from social media platforms. This results in more nuanced and accurate evaluations of each content item, allowing the online system to detect of potentially inappropriate, offensive, or controversial content items that might otherwise be missed by traditional systems.

### BRIEF DESCRIPTION OF DRAWINGS

FIG. 1A illustrates an example system environment for an online system, in accordance with some embodiments.

FIG. 1B illustrates components of an online system, in accordance with some embodiments.

FIG. 2 illustrates an example user interface for setting guidelines for review of content items, in accordance with some embodiments.

FIG. 3 illustrates an example dashboard presented by an online system, in accordance with some embodiments.

FIG. 4 illustrates an example summary displayed for a content item's risk score, in accordance with some embodiments.

FIG. 5 is a flowchart of a method for generating a dashboard for a content item, in accordance with some embodiments.

### DETAILED DESCRIPTION

A risk assessment system is an online system that uses prompts to a large language model (LLM) to identify inappropriate or improper content items posted by content creators promoting content for an advertiser. The risk assessment system may ingest social media content from a set of social media systems. The social media content may include content items that are posted by a set of content creators to those sites. For example, the social media content may include text, images, or video that the content creators have uploaded to those sites. For each ingested content item, the risk assessment system transmits a prompt to an LLM to evaluate the content item. The prompts may include any data included with their corresponding content items, such as text, images, or video. In cases where a content item includes non-text types of data, the risk assessment system may use a multi-modal LLM to evaluate the content item.

The prompt may include free text instructing the LLM to generate a score representing a likelihood that the content item violates certain standards for content that a user has set for a content creator. The risk score may be a value on a range (e.g., 0 to 1) or may indicate whether the piece of content is a “low” risk, a “medium” risk, or a “high” risk of being improper. The prompt may include instructions or guidelines for evaluating the risk of a content item. For example, the prompt may include industry-standard guidelines and instruct the LLM to use those instructions to evaluate the content item. In some embodiments, the risk assessment system allows a user to add additional or replacement guidelines for evaluating content items.

The prompt may also instruct the LLM to summarize information about the content item for review by the user. In some embodiments, the user is an advertiser or advertising entity who has hired the content creator associated with the content item, and the prompt may include instructions to identify a topic or subject of the content item (e.g., by summarizing it or by assigning a topic tag to the content item) or may include instructions to generate a summary of the content item. In some embodiments, the prompt instructs the LLM to generate an explanation of why the content item was assigned a risk score that the LLM assigned it. The risk assessment system may generate a user interface for the display to the user, where the user interface includes the risk score, summary, and any other outputs provided by the LLM based on the prompt.

Use of the risk assessment system provides technical benefits over conventional systems. By prompting LLMs based on guidelines for evaluating risk, the risk assessment system may more accurately interpret the variable and unstructured data of content items compared to conventional systems. By constructing these prompts, the risk assessment system enables the LLM to consider the informal language, slang, abbreviations, emojis, and even context-dependent meanings frequently found in content items from social media platforms. This results in more nuanced and accurate evaluations of each content item, allowing the risk assessment system to detect of “risky” (e.g., potentially inappropriate, offensive, or controversial) content items that might otherwise be missed by traditional systems.

### Example System Environment for Risk Assessment System

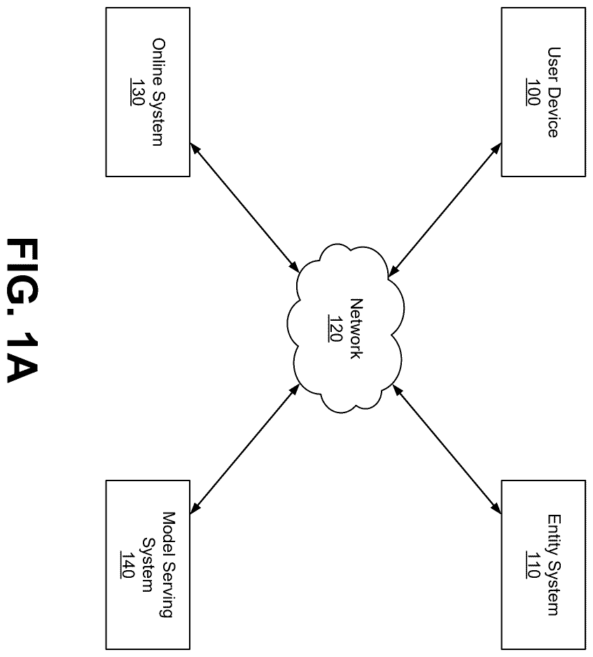

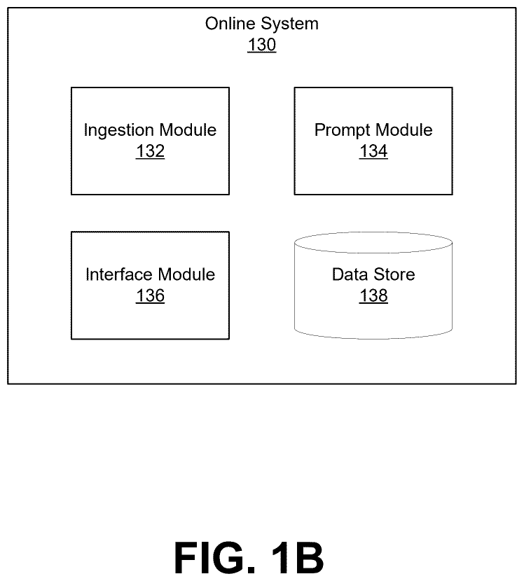

FIG. 1A illustrates an example system environment for an online system 130 (e.g., a risk assessment system), in accordance with some embodiments. The system environment illustrated in FIG. 1A includes a user device 100, an entity system 110, a network 120, the online system 130, and a model serving system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

A user can interact with other systems through a user device 100. The user device 100 can be a personal or mobile computing device, such as a smartphone, a tablet, a laptop computer, or desktop computer. In some embodiments, the user device 100 executes a client application that uses an application programming interface (API) to communicate with other systems through the network 120.

A user device 100 may be operated by a user who interacts with the entity system 110. In some embodiments, users of user devices 100 may be content creators who post content items to a social media platform provided by the entity system 110 and advertisers for whom the content creators post content items on behalf of. For example, a content creator may create a content item that is posted to the social media platform in association with an identifier of the advertiser, thus tying the meaning and context of the content item to the advertiser, despite the advertiser not having directly created or reviewed the content item.

The entity system 110 is a computing system operated by an entity. The entity may be a business, organization, or government, and, in some embodiments, the user may be an agent or employee of the entity. For example, in some embodiments, the entity system 110 may be a social media platform from which online system 130 ingests social media content (e.g., content items) for analysis.

The network 120 is a collection of computing devices that communicate via wired or wireless connections. The network 120 may include one or more local area networks (LANs) or one or more wide area networks (WANs). The network 120, as referred to herein, is an inclusive term that may refer to any or all of standard layers used to describe a physical or virtual network, such as the physical layer, the data link layer, the network layer, the transport layer, the session layer, the presentation layer, and the application layer. The network 120 may include physical media for communicating data from one computing device to another computing device, such as MPLS lines, fiber optic cables, cellular connections (e.g., 3G, 4G, or 5G spectra), or satellites. The network 120 also may use networking protocols, such as TCP/IP, HTTP, SSH, SMS, or FTP, to transmit data between computing devices. In some embodiments, the network 120 may include Bluetooth or near-field communication (NFC) technologies or protocols for local communications between computing devices. Similarly, the network 120 may use phone lines for communications. The network 120 may transmit encrypted or unencrypted data.

The model serving system 140 receives requests from other systems to perform tasks using machine-learned models. The tasks include, but are not limited to, natural language processing (NLP) tasks, audio processing tasks, image processing tasks, video processing tasks, and the like. In one embodiment, the machine-learned models deployed by the model serving system 140 are models configured to perform one or more NLP tasks. The NLP tasks include, but are not limited to, text generation, query processing, machine translation, chatbots, and the like. In one embodiment, the language model is configured as a transformer neural network architecture. Specifically, the transformer model is coupled to receive sequential data tokenized into a sequence of input tokens and generates a sequence of output tokens depending on the task to be performed.

The model serving system 140 receives a request including input data (e.g., text data, audio data, image data, or video data) and encodes the input data into a set of input tokens. The model serving system 140 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens may be arranged as a tensor with one or more dimensions, for example, one dimension, two dimensions, or three dimensions. In an example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one embodiment, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 130 or one or more entities different from the online system 130. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one embodiment, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

While the model serving system 140 is depicted as separate from the online system 130 in FIG. 1A, in alternative embodiments, the model serving system 140 is a component of the online system 130.

FIG. 1B illustrates components of the online system 130, in accordance with some embodiments. As shown in FIG. 1B, the online system 130 includes an ingestion module 132, a prompt module 134, an interface module 136, and a data store 138. In some embodiments, the online system 130 uses additional or alternative components to those described in relation to FIG. 1B or the components may interact in additional or alternative ways to those described herein.

The ingestion module 132 ingests (e.g., retrieves) content items from the entity system 110. Each content item includes data, such as text, an image, a video, or a combination of media types, that is posted, uploaded, or shared by a content creator on behalf of a user (e.g., advertiser) on a social media platform facilitated by the entity system 110. The subsets of the data may be unstructured and combined within a structure to create the content item. Each content item may include associated metadata, such as timestamps, user identifiers, captions, or tags, but the primary content itself may not be organized in a consistent format. For example, a first content item may be a post that includes three sentences, whereas another content item may be an image, and a third content item may be a video associated with a paragraph of text and five hashtags. In some embodiments, the ingestion module 132 ingesta content items endorsed by (e.g., reposted) the entity system 110. The ingestion module 132 may ingest content items periodically, in response to a request from the user, in response to a new content item being posted to the social media platform, or in response to another triggering condition.

The ingestion module 132 may identify a content creator associated with each content item. The content item also may specify an associated user. In some embodiments, the ingestion module 132 identifies the user associated with the content item and content creator by querying an index of content creators and user stored in the data store 138. In some embodiments, the ingestion module 132 receives a list of identifiers of content creators from each user, and the ingestion module 132 uses the identifiers to determine which content items to retrieve from the entity system. The ingestion module 132 may store an identifier of the content item in association with the content creator, user, and social media platform in the data store 138.

The prompt module 134 generates a prompt for each content item ingested by the ingestion module 132. The prompt is a set of text (and in some embodiments, other media such as images or videos) that instructs the LLM to generate a risk score for the content item. The risk score may be a number (e.g., 0-1) or categorical value (e.g., A, B, etc.) that represents the likelihood that the content item violates a set of standards and a set of guidelines, which are included as free text within the prompt. The set of standards are pre-defined requirements and benchmarks for a content item to meet to be considered “acceptable” types of content and may be defined by an external entity or the entity system 110. The set of standards may be applied broadly to content items posted on the social media platforms. Examples of standards include GARM “Brand Safety Floor+Suitability Framework,” community guidelines established by the social media platform, and statutory regulations that prohibit content such as hate speech, nudity, or graphic violence. In some embodiments, a user may select which of a plurality of standards for the LLM to apply.

The set of guidelines provide additional instructions for content items posted by content creators in association with the user and may be set by the entity system 110. The guidelines are provide by the user and indicate what type of content the user deems allowable in the content item and what type of content the user deems as not allowed in the content item. Guidelines may include particular words, phrases, topics, or depictions to avoid and acceptable contexts for certain behaviors. For example, a guideline may indicate that depictions of violence are permissible only in the context of news reporting or educational documentaries, provided they are appropriately labeled and not sensationalized.

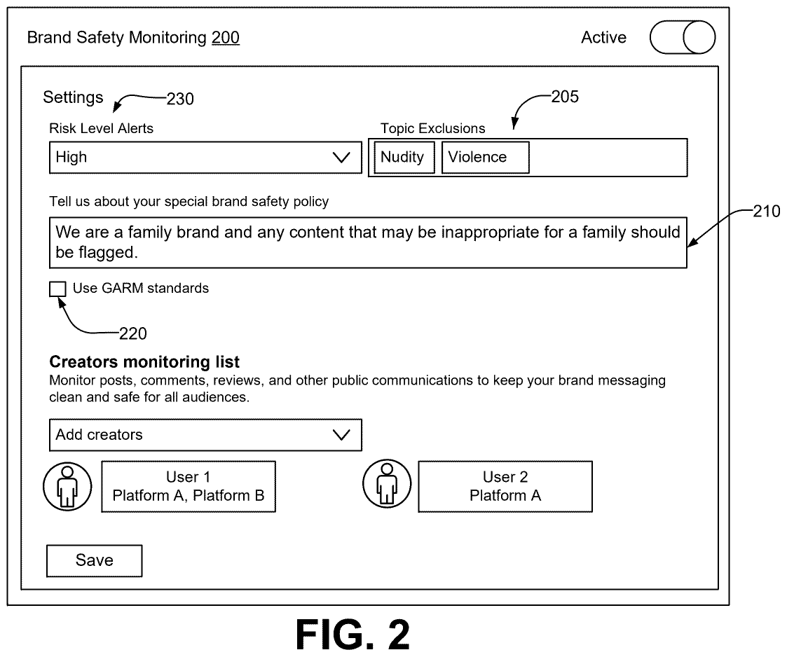

The user may provide guidelines via a user interface presented by at a user device 100, as is further described in relation to FIG. 2. The guidelines may include both general guidelines to be applied for scoring each content item and specific guidelines for a subset of content items that meet one or more requirements. The requirements may include that the content item is of a particular content type (e.g., text, images, etc.), created by one or more specific content creators, or related to one or more particular subjects (e.g., sports, women's shoes, laundry detergent, etc.). In some embodiments, the prompt module 134 receives guidelines via the interface module 136, which may cause client devices to present of user interfaces configured to receive guidelines and other information for a prompt from the entity system 110.

The prompt module 134 generates a prompt for a content item with free text describing the standards and guidelines, free text for instructions on how to generate the risk score, or data describing or associated with the corresponding content item, such as text, images, or video. The instructions for generating the risk score includes how to assign a number or categorical value and may include one or more guidelines or standard. In some embodiments, the prompt also includes instructions to provide an explanation for the generated risk score. The prompt module 134 provides the prompt to an LLM (or other language model) of model serving system 140. In some embodiments, the prompt module 134 stores the prompt in association with the content item in the data store 138.

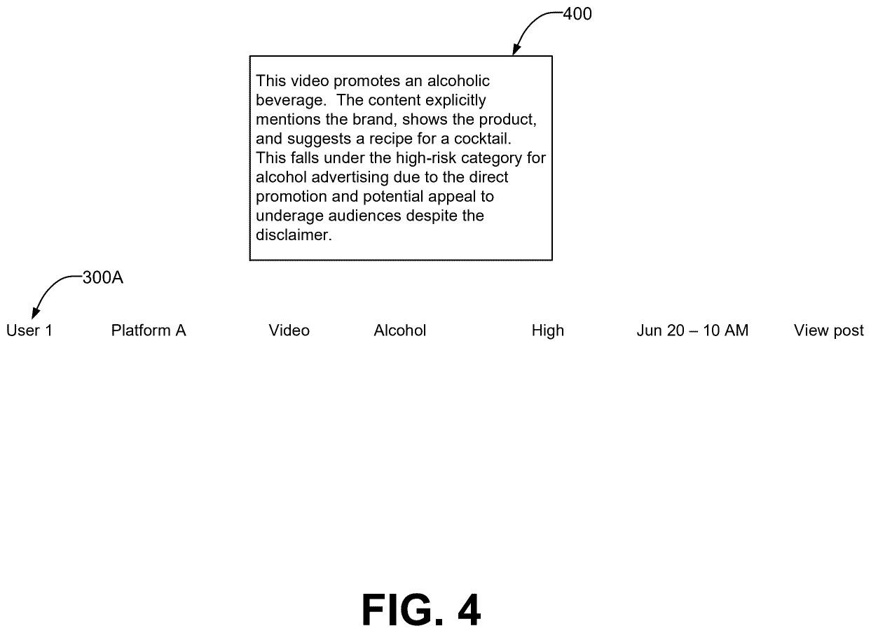

The interface module 136 receives a response from the LLM for each generated prompt. A response includes the risk score and may include an explanation for how the risk score was determined for the content item. The explanation may describe specific qualities of the content item or content within the content item that contributed to the determination of the risk score. An example of an explanation is described in relation to FIG. 4 below.

The interface module 136 generates a dashboard including the risk scores of each content item associated with a response. In some embodiments, the interface module 136 only includes the risk score of one or more content items specified by the entity system 110. The interface module 136 may generate a row in the dashboard for each content item. The row may describes the content creator who created the content item, the social media platform on which the content item was posted, one or more content types of the content item (e.g., image and text, only video, etc.), a topic associated with the content item, the risk score associated with the content item, and a link to view the content item. The dashboard is further described in relation to FIG. 2.

In some embodiments, the prompt module 134 further moderates content items posted for the user based on the determined risk scores. The user may provide parameters including one or more triggering conditions and associated actions for the prompt module 134 to take when a triggering condition is met. The user may provide the parameters via a user interface, such as the user interface described in relation to FIG. 2. For example, the user may indicate a triggering condition of a risk score exceeding a threshold and specify that in response to detecting a risk score that meets this triggering condition, the prompt module 134 is to automatically flag the content item for user approval, remove the content item or sub-content items (e.g., removing posts or comments) from the social media platform, disassociate the content item from an identifier of the user at the social media platform (e.g., untagging the user from the content item), and the like. The parameters may also include requirements for a content item to meet for the prompt module 134 to apply other parameters to a risk score for the content item.

In some embodiments, the prompt module 134 may evaluate sub-content of a content item individually, in addition or alternative to evaluation of the entire content item, based on the parameters. Sub-content may include media items (e.g., images, audio, video) within the content item and disparate sets of text associated with the content item, such as individual comments, hashtags, or captions. The prompt module 134 may provide a content item with instructions to identify sub-content of the content item to an LLM. The prompt module 134 may request a risk score for each identified sub-content of a content item in the one or more prompts (e.g., one prompt requesting a risk score for each sub-content or a prompt for each sub-content). In some embodiments, the prompt module 134 may perform preprocessing steps for evaluating sub-content such that the prompt module 134 may include information about the sub-content in a prompt in a standardized format. For example, the prompt module 134 may insert the sub-content into a schema within the prompt that the LLM is trained to interpret. The prompt module 134 may take alter or remove sub-content that meets a triggering condition while otherwise maintaining the rest of the content item as posted. For example, if the prompt module 134 detects a comment with a risk score that exceeds the threshold, the prompt module 134 may remove the comment but leave the image that the comment was posted in relation to.

FIG. 2 illustrates an example user interface 200 for setting standards and guidelines for review of content items, in accordance with some embodiments. The user interface 200 may be provided to the user and include information for content items posted by one or more content creators on behalf of the user. The user interface 200 includes a plurality of interactive elements that the user can interact with to specify standards, guidelines, or other settings for prompts. For instance, the user interface 200 allows the user to list topics 205 that should be considered inappropriate or that the user would otherwise like to associate with a high risk score. The user interface 200 may also receive text of specific instructions 210 for the LLM to apply in assigning a risk score to a content item. The instructions 210 may include standards or guidelines specified by the user. For example, in FIG. 2, a guideline shown in the instructions 210 is to flag “any content that may be inappropriate for a family.” The user interface also allows the user to select one or more pre-defined standards, such as the GARM standards, instead of or in addition to the more-specific instructions 210 to use as instructions 220 for computing risk scores. The user interface 200 also allows the user to set a threshold risk score 230 for receiving an alert regarding a content item analyzed by the risk assessment system.

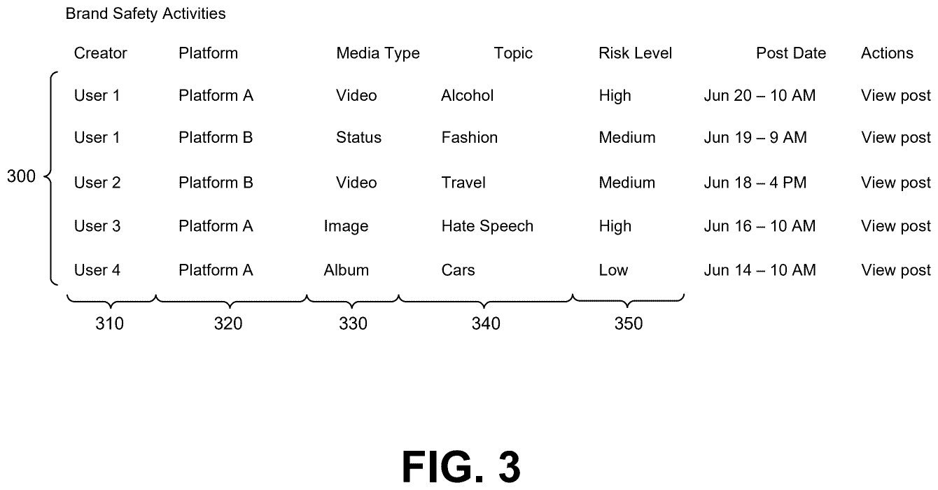

FIG. 3 illustrates an example dashboard presented by an online system, in accordance with some embodiments. The dashboard may be presented in a user interface and includes a plurality of rows 300, where each row is associated with a content item that was scored by the online system 130. Each row includes information related to the respective content item, such as the creator 310 of the content item, a platform 320 the content item was posted on, a topic 340 of the content item, a risk level 350 associated with the content item, a timestamp associated with posting of the content item, and an interactive element that causes the user interface to display the respective content item in response to receiving an interaction. The risk level may be a category of the risk score associated with the content item, where the category is associated with a score range that the risk score is within. For example, a risk score of 98% may be categorized with a “high” risk level, whereas a risk score of 50% may be categorized with a “medium” risk level. In some embodiments, the dashboard includes the risk scores themselves rather than a risk level associated with each risk score.

In some embodiments, a user may interact with a row 300A to display a summary 400 (or explanation) for the content item's risk score, as is shown in FIG. 4. For example, the user may hover over the risk level for a content item to view a summary 400 of why the content item was assigned the risk score that it was. Hovering may include moving a cursor over the risk and interacting with a touch-screen that is displaying the risk level, such as by pressing and holding the touch-screen at the corresponding part of the display.

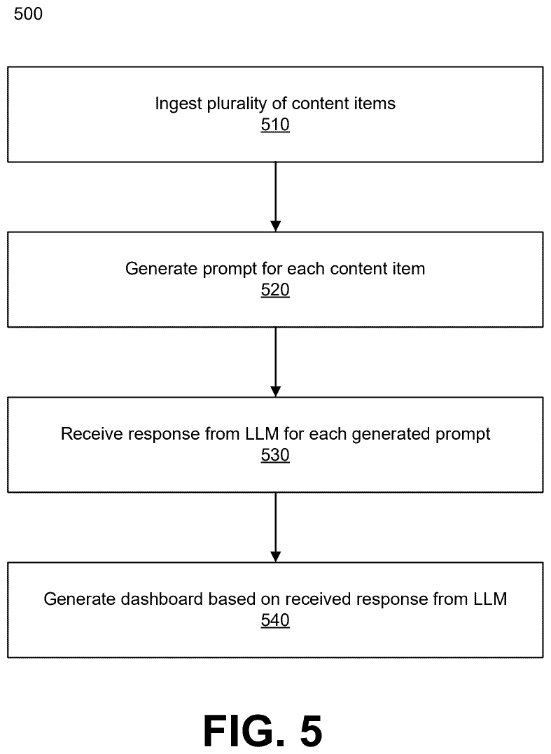

FIG. 5 is a flowchart of a method 500 for generating a dashboard for a content item, in accordance with some embodiments. In some embodiments, the method 500 includes additional or alternative steps to those shown in FIG. 5 or the steps may be executed by additional or alternative components to those described in relation to FIG. 5.

The method 500 begins with ingesting 510 a plurality of content items from one or more social media platforms, each associated with an entity system 110. Each content item is associated with a content creator sponsored by an advertiser to create content items about products or services specified by the advertiser and includes one or more of free text, an image, a video, and audio. For each of the content items, the prompt module 134 generates 520 a prompt to language model of the model serving system 140. Each prompt instructs the language model to generate a risk score for a respective content item and an explanation for the generated risk score. The prompt may include one or more of free text for the instructions 210, free text describing instructions 220 for generating a risk score, text describing or associated with the respective content item, and an image or video associated with the respective content item. The interface module 1336 receives 530 a response from the language model for each generated prompt and generates a dashboard for the content items based on the received response from the language model. The dashboard may include a row 300 associated with each content item. The row 300 for a content item may describe at least one of the content creator 310 who created the content item, a social media platform 320 on which the content item was posted, a type 330 of the content item, a topic 340 associated with the content item, a risk level 350 or risk score associated with the content item, and a link to view the content item. In some embodiments, the dashboard may only include rows for content items that meet one or more conditions selected by the advertiser, such as a threshold risk score or specific topic.

In some embodiments, the interface module 136 generates a user interface including one or more interactive elements configured to receive the free text for instructions and the free text describing the instructions for generating risk scores and causes a user device 100 to present the user interface. The free text for instructions includes one or more guidelines provided via the user device 100 and indicate what type of content is allowed in content items posted to the one or more social media platforms and what type of content is not allowed in content items posted to the one or more social media platforms. Content items including any content that is not allowed may be associated with a higher risk score than content items that only include content that is allowed. In some embodiments, the type of content that is not allowed in the content item includes one or more particular words, phrases, topics, or depictions.

In some embodiments, a subset of the guidelines are specific guidelines for content items that meet one or more requirements. The requirements may include one or more of the content item including a particular media item, the content item being created by one or more particular content creators, and the content being related to one or more particular topics. In some embodiments, the instructions for generating the risk score includes instructions on how to assign a number or categorical value to a respective content item or one or more standards that indicate unacceptable types of content within content items. For example, the standards may include one or more of industry-standard guidelines, community guidelines established by the one or more social media platforms, and statutory regulations. In some embodiments, the prompt module 134 compares, for each content item, the risk score of the respective content item to a risk threshold. In response to the risk score exceeding the risk threshold, the prompt module 134 performs a remedial action in relation to the content item. Examples of remedial actions include removing the content item from the one or more social media platforms, removing an association with the content item to the advertiser, and flagging the content item for review by the advertiser.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method comprising:
receiving, by a risk assessment system, a plurality of content items from one or more online platforms, wherein each content item is associated with a content creator sponsored by a user;
generating a prompt to a generative language model for each of the content items, wherein the prompt includes free text describing instructions that cause the generative language model to generate a risk score for the respective content item and an explanation for the generated risk score in response to being provided with the prompt, wherein the prompt further comprises and text describing or associated with the respective content item;
receiving a response from the generative language model for each generated prompt, wherein each response comprises the respective risk score and respective explanation for the respective risk score;
generating a dashboard user interface based on the received response from the generative language model, wherein the dashboard user interface includes a row for each content item, wherein each row describes at least one of the content creator who created the content item, the risk score associated with the content item, and a link to view the content item; and
transmitting instructions to a client device to display the dashboard user interface.

2. The method of claim 1, wherein the content item includes one or more of free text, an image, a video, and audio.

3. The method of claim 1, further comprising:
generating a settings user interface including one or more interactive elements configured to receive the free text describing the instructions for generating the risk score; and
causing a user device to present the user interface.

4. The method of claim 1, wherein the free text further includes one or more guidelines provided via the user device, wherein the guidelines indicate what type of content is allowed in the content item and what type of content is not allowed in the content item, the method of claim 1 further comprising:
receiving a first response associated with a first content item that includes content that is not allowed, wherein the response includes a first risk score; and
receiving a second response associated with a second content item includes only content that is allowed, wherein the second response includes a second risk score that is lower than the first risk score.

5. The method of claim 4, wherein the type of content that is not allowed in the content item includes one or more particular words, phrases, topics, or depictions.

6. The method of claim 4, wherein a subset of the guidelines are specific guidelines for content items that meet one or more requirements, the requirements including one or more of the content item including a particular media item, the content item being created by one or more particular content creators, and the content being related to one or more particular topics.

7. The method of claim 3, wherein the instructions for generating the risk score include instructions on how to assign a number or categorical value to a respective content item.

8. The method of claim 3, wherein the instructions for generating the risk score include one or more standards, wherein the one or more standards indicate unacceptable types of content within content items.

9. The method of claim 8, wherein the prompt further comprises an image or video associated with the respective content item.

10. The method of claim 1, further comprising:
comparing, for each content item, the risk score of the respective content item to a risk threshold; and
in response to the risk score exceeding the risk threshold, performing a remedial action in relation to the content item, wherein the remedial action includes one or more of removing the content item from the one or more online platforms, removing an association with the content item to the user, and flagging the content item for review by the user.

11. The method of claim 1, wherein each row further describes an online platform on which the respective content item was posted, a type of the respective content item, a topic associated with the respective content item.

12. The method of claim 1, wherein the risk score is a category or a number.

13. A non-transitory computer-readable storage medium storing instructions that, when executed, cause a processor to perform steps comprising:
receiving, by a risk assessment system, a plurality of content items from one or more online platforms, wherein each content item is associated with a content creator sponsored by a user;
generating a prompt to a generative language model for each of the content items, wherein the prompt includes free text describing a first set of instructions that cause the generative language model to generate a risk score for the respective content item and an explanation for the generated risk score in response to being provided with the prompt, wherein the prompt further comprises and text describing or associated with the respective content item;
receiving a response from the generative language model for each generated prompt, wherein each response comprises the respective risk score and respective explanation for the respective risk score;
generating a dashboard user interface based on the received response from the generative language model, wherein the dashboard user interface includes a row for each content item, wherein each row describes at least one of the content creator who created the content item, the risk score associated with the content item, and a link to view the content item; and
transmitting a second set of instructions to a client device to display the dashboard user interface.

14. The non-transitory computer-readable storage medium of claim 13, wherein the content item includes one or more of free text, an image, a video, and audio.

15. The non-transitory computer-readable storage medium of claim 13, the steps further comprising:
generating a settings user interface including one or more interactive elements configured to receive the free text describing the first set of instructions for generating the risk score; and
causing a user device to present the user interface.

16. The non-transitory computer-readable storage medium of claim 13, wherein the free text further includes one or more guidelines provided via the user device, wherein the guidelines indicate what type of content is allowed in the content item and what type of content is not allowed in the content item, the steps further comprising:
receiving a first response associated with a first content item that includes content that is not allowed, wherein the response includes a first risk score; and
receiving a second response associated with a second content item includes only content that is allowed, wherein the second response includes a second risk score that is lower than the first risk score.

17. The non-transitory computer-readable storage medium of claim 13, the steps further comprising:
comparing, for each content item, the risk score of the respective content item to a risk threshold; and
in response to the risk score exceeding the risk threshold, performing a remedial action in relation to the content item, wherein the remedial action includes one or more of removing the content item from the one or more online platforms, removing an association with the content item to the user, and flagging the content item for review by the user.

18. The non-transitory computer-readable storage medium of claim 13, wherein each row further describes an online platform on which the respective content item was posted, a type of the respective content item, a topic associated with the respective content item.

19. The non-transitory computer-readable storage medium of claim 13, wherein the risk score is a category or a number.

20. A system comprising:
a processor; and
a non-transitory computer-readable storage medium storing instructions that, when executed, cause the processor to perform steps comprising:
receiving, by a risk assessment system, a plurality of content items from one or more online platforms, wherein each content item is associated with a content creator sponsored by a user;
generating a prompt to a generative language model for each of the content items, wherein the prompt includes free text describing a first set of instructions that cause the generative language model to generate a risk score for the respective content item and an explanation for the generated risk score in response to being provided with the prompt, wherein the prompt further comprises and text describing or associated with the respective content item;
receiving a response from the generative language model for each generated prompt, wherein each response comprises the respective risk score and respective explanation for the respective risk score;
generating a dashboard user interface based on the received response from the generative language model, wherein the dashboard user interface includes a row for each content item, wherein each row describes at least one of the content creator who created the content item, the risk score associated with the content item, and a link to view the content item; and
transmitting a second set of instructions to a client device to display the dashboard user interface.
